(19) United States
(12) Patent Application Publication
(10) Pub. No.: US 2011/0063853 A1
(43) Pub. Date: Mar. 17, 2011

(54) LASER LINER

(76) Inventor: TE-TIEN LIN, Taichung City (TW)

(21) Appl. No.: 12/558,022

(22) Filed: Sep. 11, 2009

(51) Int. Cl. F21V 5/02; F21V 5/00; G02B 13/18

(52) U.S. Cl. 362/311.02; 362/311.09; 359/709

(57) ABSTRACT

A laser liner includes a light module, a condensing lens and a cylindrical diverging lens. The light module produces a point source of light, which penetrating through the condensing lens to form a surface source of light. The diverging lens has a plane surface facing the condensing lens and a surface opposite to the plane surface, and the surface opposite to the plane surface has a concave right circular conical surface. A ratio of a length of a generatrix of the conical surface to a diameter of a directrix of the conical surface is \sqrt{2}/2, wherein as the light emitted from the surface source enters the diverging lens from the plane surface, the light entering the diverging lens is reflected by the conical surface to form a reflected light, and an included angle between the reflected light and an axis of the conical surface is 90 degrees.

### BACKGROUND OF THE INVENTION

1. Field of the Invention

The present invention relates to a laser liner.

2. Description of the Prior Art

Refer to FIG. 1 for a multidirectional laser pointer of a Taiwanese patent numbered 570188. A light module 1 emits light 6 passing through a condensing lens 2 and a bar-shaped lens 3, the emitted light 6 is thereafter refracted to form refracted light 4A with a maximum aperture of 120-150 degrees.

Refer to FIG. 2. To increase the maximum aperture of the emitted light, a conical pole 5 is provided in substitution for the bar-shaped lens. The light 6 is reflected by the conical pole 5 to form reflected light 4B with a maximum aperture of 180 degrees.

However, such conical pole 5 is hard to assembled and easily damaged during the assembling procedure, and it has to be positioned by a supporter 7, which screens part of the scattered light 4B.

### SUMMARY OF THE INVENTION

The main object of the present invention is to provide a laser liner that is easily-assemblable and is suitable to emit reflected light with a maximum aperture of 180 degrees.

To achieve the above object, a laser liner is provided. The laser liner includes a light module, a condensing lens and a cylindrical diverging lens. The light module produces a point source of light, which penetrating through the condensing lens to form a surface source of light. The diverging lens is disposed next to the condensing lens and has a plane surface facing the condensing lens. The diverging lens further has a surface opposite to the plane surface, and the surface opposite to the plane surface has a concave right circular conical surface. A ratio of a length of a generatrix of the conical surface to a diameter of a directrix of the conical surface is \sqrt{2}2, wherein as the light emitted from the surface source enters the diverging lens from the plane surface, the light entering the diverging lens is reflected by the conical surface to form a reflected light, and an included angle between the reflected light and an axis of the conical surface is 90 degrees.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a profile showing a first prior art;

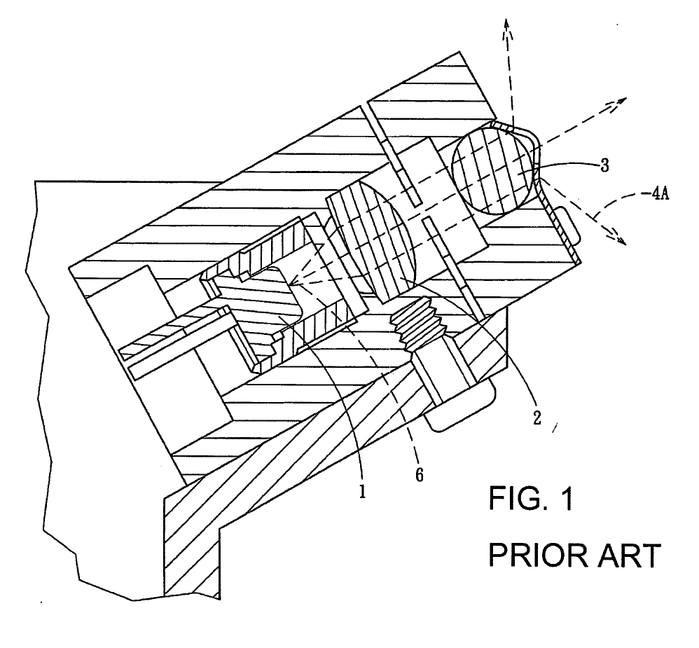

FIG. 2 is a profile showing a second prior art;

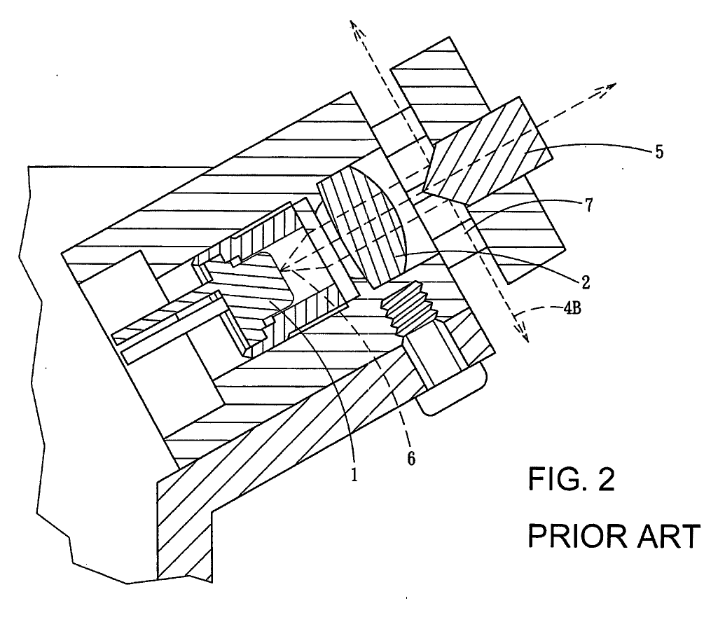

FIG. 3A is a profile showing a laser liner in accordance with a preferred embodiment of the present invention;

FIG. 3B is a profile showing a laser liner at another view angle in accordance with a preferred embodiment of the present invention;

FIG. 4 is an explosive drawing showing a laser liner in accordance with a preferred embodiment of the present invention;

FIG. 5 is a profile showing a path of laser in a laser liner in accordance with a preferred embodiment of the present invention.

### DETAILED DESCRIPTION OF THE PREFERRED EMBODIMENTS

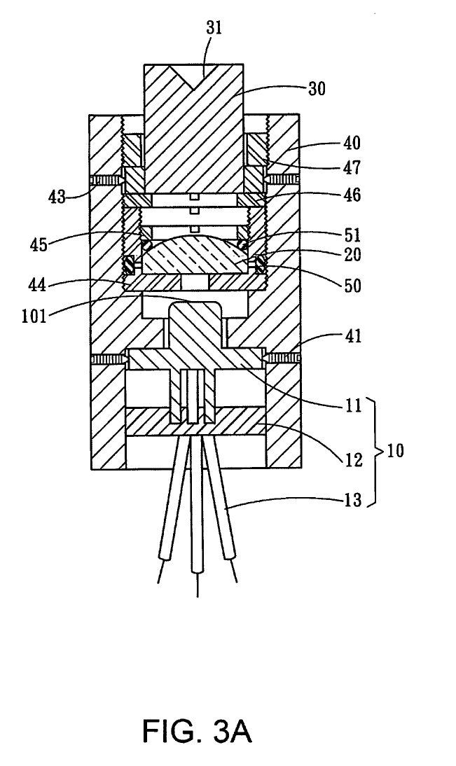

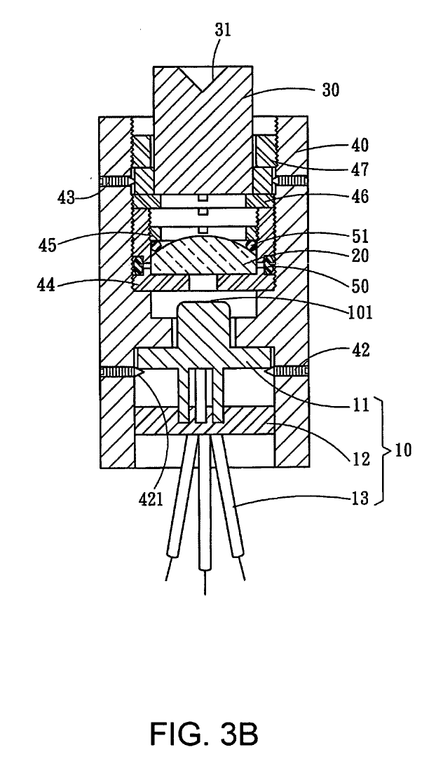

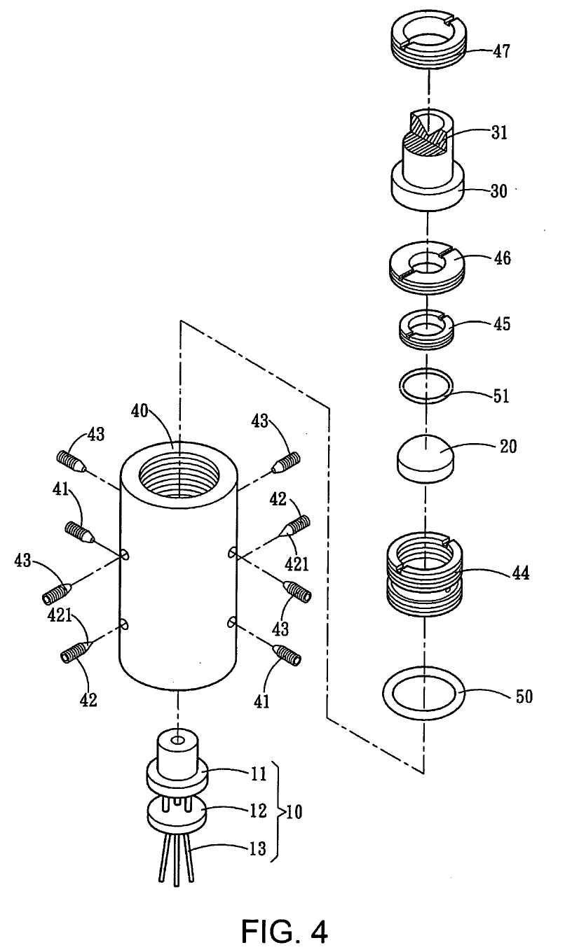

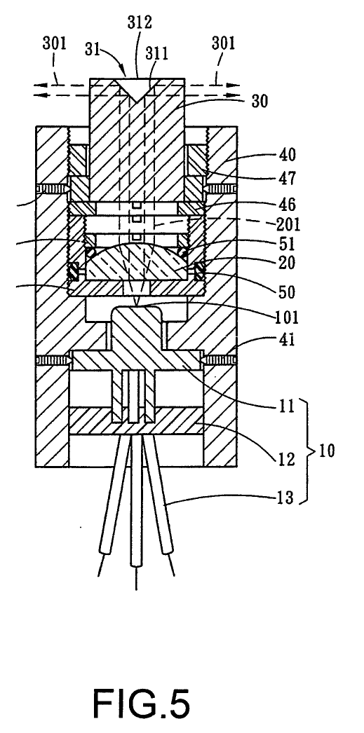

Refer to FIG. 3A, FIG. 3B and FIG. 4-5. A laser liner of the present invention includes a light module 10, a condensing lens 20 and a cylindrical diverging lens 30. The light module 10 is used to produce a point source of light. The condensing lens 20 is disposed next to the light module 10. Light 101 emitted from the point source penetrates through the condensing lens 20 to condense into a surface source of light. The diverging lens 30 is disposed next to the condensing lens 20 and away from the light module 10, i.e. the condensing lens 20 is disposed between the light module 10 and the diverging lens 30. The diverging lens 30 has a plane surface facing the condensing lens 20, and the diverging lens 30 further has a surface opposite to the plane surface. The surface opposite to the plane surface has a concave right circular conical surface 31 formed thereon. A ratio of a length of a generatrix of the conical surface 31 to a diameter of a directrix of the conical surface 31 is \sqrt{2}2. Specifically, in a vertical profile passing through an apex of the conical surface 31, the section of the conical surface 31 is an isosceles right triangle. The length of the generatrix is exactly the length of each equal side of the isosceles right triangle, and the diameter of the directrix is exactly the length of the hypotenuse of the isosceles right triangle. As light 201 emitted from the surface source enters the diverging lens 30 from the plane surface, the light entering the diverging lens 30 is reflected by the conical surface 30 to form a reflected light 301. Thus, an included angle between the reflected light 301 and an axis of the conical surface is 90 degrees, i.e. the maximum aperture of the reflected light 301, which is the angle between two opposite reflected light 301, is 180 degrees.

The laser liner further includes a shell 30, which is a hollow cylinder. The light module 10 and the diverging lens 30 are disposed on two opposite end of the shell 40 while sandwiching the condensing lens 20.

There are two first positioners 41 and two adjusting elements 42 disposed on the shell 40. The first positioners 41 clamp the light module 10 from two opposite side of the shell 40. A distal end of each adjusting element 42 has a conical surface to abut against a bottom surface of the light module 10. The adjusting element 42 is then adjustable to move toward or away from the interior of the shell 40, further adjusting the position of the light module 10 such that the light module 10 and the shell 40 are coaxial.

The light module 10 can be a laser module or a LED module, and the light module 10 includes a light source generator 11, a print circuit board 12 and an electric contact 13. The light source generator 11 is disposed on the print circuit board 12 and electrically connects to the electric contact 13. The first positioners 41 thus clamp the light source generator 11, and the conical surfaces of the adjusting elements 42 abut against a bottom surface of the light source generator 11.

There are at least three second positioners 43 (four second positioners are shown in the drawings) disposed on the shell 40 and clamping the diverging lens 30. The second positioners 43 are used to adjust the level position of the diverging lens 30 such that the diverging lens 30, the condensing lens 20 and the light module 10 are coaxial.

The condensing lens 20 may be an aspherical lens, and it is sandwiched between a first positioning body 44 and a second positioning body 45. The first positioning body 44 is cap-shaped, and the second positioning body 45 is disc-shaped. The cap-shaped first positioning body 44 defines a receiving space to receive the condensing lens 20 therein, and the second positioning body 45 is thereafter mate with the side wall of the receiving space to position the condensing lens 20. A resilient ring 51 may installed between the condensing lens 20 and the second positioning body 45 to further secure the condensing lens 20. The first positioning body 44 is suitable to mate with the shell 40 with a resilient ring 50 disposed between the first positioning body 44 and the shell 40.

The diverging lens 30 can be made of polycarbonate (PC) or cyclo-olefin polymer (COP). An annular flange is formed on the periphery of the diverging lens 30, and it is sandwiched by a third positioning body 46 and a fourth positioning body 47. The second positioners 43 are, for instance, used to clamp the flange of the diverging lens 30.

In summary, the light module 10 is adjustable by adjusting the first positioners 41 and the adjusting elements 42, and the second positioners 43 is used to adjust the level position of the diverging lens 30, such that the light module 10, the condensing lens 20 and the diverging lens 30 are coaxial. Furthermore, the diverging lens 30 is easily assembled and is suitable to reflect light without screen.

What is claimed is:

1. A laser liner, comprising:
a light module, producing a point source of light;
a condensing lens, disposed next to the light module, light emitted from the point source penetrating through the condensing lens to form a surface source of light; and
a cylindrical diverging lens, disposed next to the condensing lens and away from the light module, the diverging lens having a plane surface facing the condensing lens, the diverging lens having a surface opposite to the plane surface, the surface opposite to the plane surface having a concave right circular conical surface, a ratio of a length of a generatrix of the conical surface to a diameter of a directrix of the conical surface is \sqrt{2}2, wherein as light emitted from the surface source enters the diverging lens from the plane surface, the light entering the diverging lens is reflected by the conical surface to form a reflected light, and an included angle between the reflected light and an axis of the conical surface is 90 degrees.

2. The laser liner of claim 1, further comprising a hollow cylindrical shell, the light module and the diverging lens being disposed on two opposite end of the shell respectively, the condensing lens being disposed between the diverging lens and the light module.

3. The laser liner of claim 2, wherein two first positioners and two adjusting elements are disposed on the shell, the first positioners clamp the light module from two opposite side of the shell, and a distal end of each adjusting element has a conical surface to abut against a bottom surface of the light module.

4. The laser liner of claim 3, wherein the light module comprises a light source generator, a print circuit board and an electric contact, the light source generator is disposed on the print circuit hoard and electrically connects to the electric contact, the first positioners clamp the light source generator, the conical surfaces of the adjusting elements abut against a bottom surface of the light source generator.

5. The laser liner of claim 2, wherein at least three second positioners are disposed on the shell, the second positioners clamp the diverging lens.

6. The laser liner of claim 2, wherein the condensing lens is sandwiched between a first positioning body and a second positioning body, the first positioning body mates with the shell, and the second positioning body mates with the first positioning body.

7. The laser liner of claim 6, wherein an annular flange is formed on the diverging lens, the annular flange is sandwiched by a third positioning body and a fourth positioning body, the first positioning body is cap-shaped, and the second positioning body is disc-shaped.

8. The laser liner of claim 1, wherein the condensing lens is an aspherical lens.

9. The laser liner of claim 1, wherein light module is a laser module or an LED module.

10. The laser liner of claim 1, wherein the diverging lens is made of polycarbonate.
